(19) United States
(12) Patent Application Publication
(10) Pub. No.: US 2026/0225017 A1
(43) Pub. Date: Aug. 6, 2026

(54) AIR PURIFIER

(71) Applicant: Brother Kogyo Kabushiki Kaisha, Nagoya (JP)

(72) Inventors: Shingo Katayama, Nisshin (JP); Ryuta Iijima, Nagoya (JP); Kotaro Kurokawa, Gifu (JP); Naokatsu Osawa, Nagoya (JP); Masaaki Furukawa, Nagoya (JP); Junji Yamano, Kariya (JP); Norikazu Kondo, Okazaki (JP)

(21) Appl. No.: 19/631,135

(22) Filed: Mar. 27, 2026

Related U.S. Application Data
(63) Continuation of application No. PCT/JP2024/032861, filed on Sep. 13, 2024.

(30) Foreign Application Priority Data
Sep. 29, 2023 (JP) 2023-170597

(51) Int. Cl. B01D 46/00; B01D 46/62; F24F 8/108

(52) U.S. Cl. CPC B01D 46/0047; B01D 46/0005; B01D 46/62; F24F 8/108; B01D 2273/30

(57) ABSTRACT

An air purifier includes a fan unit and a support rotatably supporting the fan unit about a first axis extending in a horizontal direction. The fan unit includes a first housing, a fan disposed inside the first housing, and a purification member. The first housing has a first wall surface provided with a first inlet for drawing in air, and a second wall surface provided with an outlet for discharging air. The first wall surface is located at a position intersecting a second axis orthogonal to the first axis. When a direction that is parallel to the second axis and extends from the first wall surface toward the fan is defined as a specific direction and the first inlet is entirely located above the fan in a vertical direction, the first inlet is located at the most upstream position of the air purifier in the specific direction.

### REFERENCE TO RELATED APPLICATIONS

This is a continuation application of International Application No. PCT/JP2024/032861 filed on September 13, 2024, which claims priority from Japanese Patent Application No. 2023-170597 filed on September 29, 2023. The entire contents of the aforementioned applications are incorporated herein by reference.

### TECHNICAL FIELD

The present disclosure relates to an air purifier.

### BACKGROUND ART

An air purifier capable of changing the direction in which its air inlet faces has been proposed. For example, a local purification type air purifier described in Patent Literature 1 includes a main body and a support portion. The main body has a casing with an air inlet and an air outlet. Inside the casing, a fan motor, a fan, a filter, a photo catalyst, and a light source are provided. The fan is rotated by the fan motor, thereby drawing air in through the air inlet. The drawn-in air is purified by the filter and the photo catalyst. The purified air is discharged from the air outlet. The support portion includes a base member, a pair of support members, and a connecting member. The pair of support members extend upward from the base member. The pair of support members rotatably support the main body. As the main body rotates, the direction in which the air outlet faces changes. The connecting member is provided over the upper ends of the pair of support members.

### SUMMARY

The local purification type air purifier described in Patent Literature 1 may be used with the main body rotated so that the air inlet faces upward and the air outlet faces downward. In this case, the flow of the air drawn toward the air inlet may be obstructed by the connecting member of the support portion. This situation presents a problem that the efficiency of air purification by the filter and the photo catalyst in the main body decreases.

The object of the present disclosure is to provide an air purifier that can stably maintain air purification efficiency regardless of the direction in which an air inlet faces.

According to an aspect of the present disclosure, an air purifier includes a fan unit and a support. The fan unit includes a first housing, a fan, and a purification member. The first housing has a first wall surface provided with a first inlet for drawing in air, and a second wall surface provided with an outlet for discharging air. The fan is disposed inside the first housing to draw in air through the first inlet. The purification member purifies the air. The support rotatably supports the fan unit about a first axis that is an imaginary line extending in a horizontal direction. The first wall surface is located at a position intersecting a second axis that is an imaginary line orthogonal to the first axis. When a direction that is parallel to the second axis and extends from the first wall surface toward the fan is defined as a specific direction and the first inlet is entirely located above the fan in a vertical direction, the first inlet is located at the most upstream position of the air purifier in the specific direction.

In the air purifier, the flow of air drawn toward the first inlet is unobstructed by the other components of the air purifier. The air purifier can stably maintain the efficiency of air purification by the purification member of the fan unit, regardless of the direction in which the first inlet faces.

### BRIEF DESCRIPTION OF THE DRAWINGS

FIG. 1 is a perspective view of an air purifier 1 as viewed from above.

FIG. 2 is a front view of the air purifier 1.

FIG. 3 is a perspective view of the air purifier 1 as viewed from below.

FIG. 4 is a perspective view of a base 21.

FIG. 5 is a perspective view of the air purifier 1 with a first housing 50 and a flow directing member 26 detached.

FIG. 6 is a perspective view of the flow directing member 26.

FIG. 7 is a perspective view illustrating the internal configuration of a right support 3R.

FIG. 8 is a perspective view illustrating the internal configuration of a left support 3L.

FIG. 9 is a left side view illustrating a left protruding portion 57L, a restriction plate 35, a cable 58, and a guide portion 59.

FIG. 10 is a cross-sectional view taken along the line X-X in FIG. 1 and viewed in the direction of the arrow.

FIG. 11 is a perspective view illustrating the internal configuration of a base body 2, a support 3, and a second accommodating body 520.

FIG. 12 is a perspective view of a first filter 7 and a second filter 8 as viewed from below.

FIG. 13 is a perspective view of a fan 6 as viewed from above.

FIG. 14 is a left side view illustrating the left protruding portion 57L, the restriction plate 35, the cable 58, and the guide portion 59.

FIG. 15 is a view illustrating heights from a placement surface to the lowest point and the highest point of a first inlet 55.

### DESCRIPTION

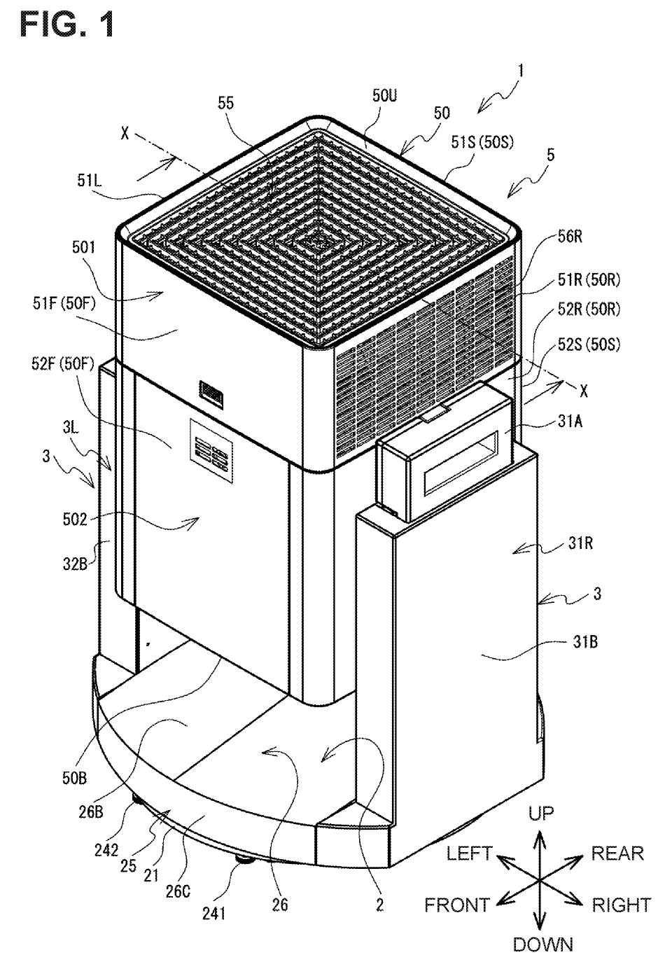

An air purifier 1 according to an embodiment of the present disclosure will be described with reference to the drawings. The drawings referred to are used to illustrate the technical features that may be employed by the present disclosure. The configuration of the apparatus described herein is not intended to be limited to the configuration described herein, but is merely illustrative. In FIG. 1, the upper, lower, left lower, right upper, right lower, and left upper are the upper, lower, front, rear, right, and left of the air purifier 1, respectively. The up and down direction is referred to as the "vertical direction".

### Outline of Air Purifier 1

The air purifier 1 draws air inside and removes dust, allergens such as mold and pollen, viruses and bacteria, odors, and the like (hereinafter referred to as "removal targets") from the air within the air purifier 1. The air purifier 1 discharges air, from which the removal targets have been removed, to the outside. The air purifier 1 thus purifies the surrounding air. As illustrated in FIG. 1, the air purifier 1 has a base body 2, a support 3, and a fan unit 5.

### Base Body 2

The base body 2 is placed on a placement surface when the air purifier 1 is installed. The base body 2 supports the support 3 and the fan unit 5, which will be described later, from below. As illustrated in FIGS. 1 to 3, the base body 2 has a base 21 and a frame 25.

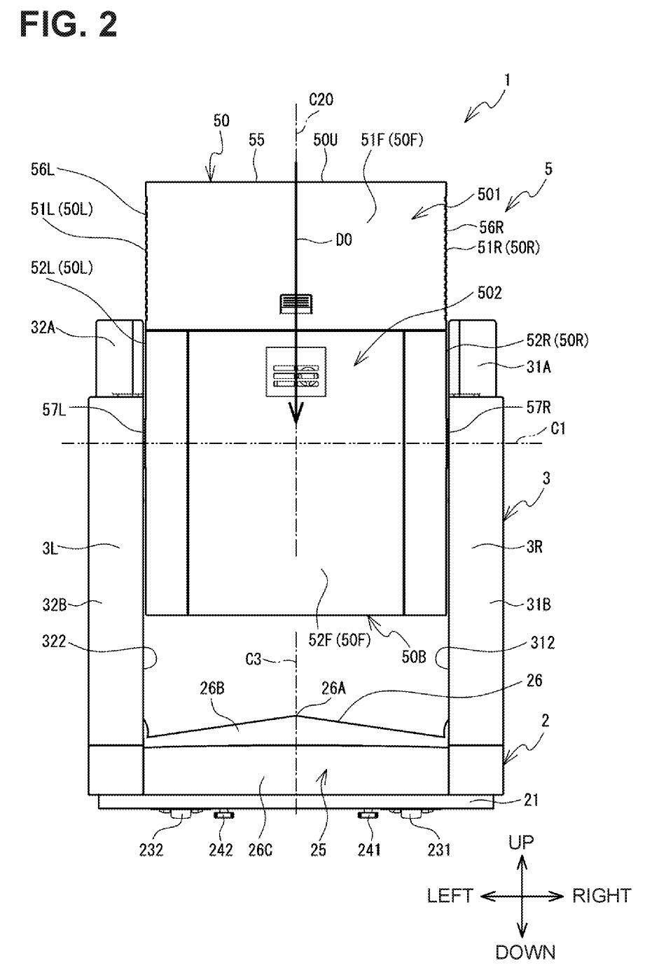

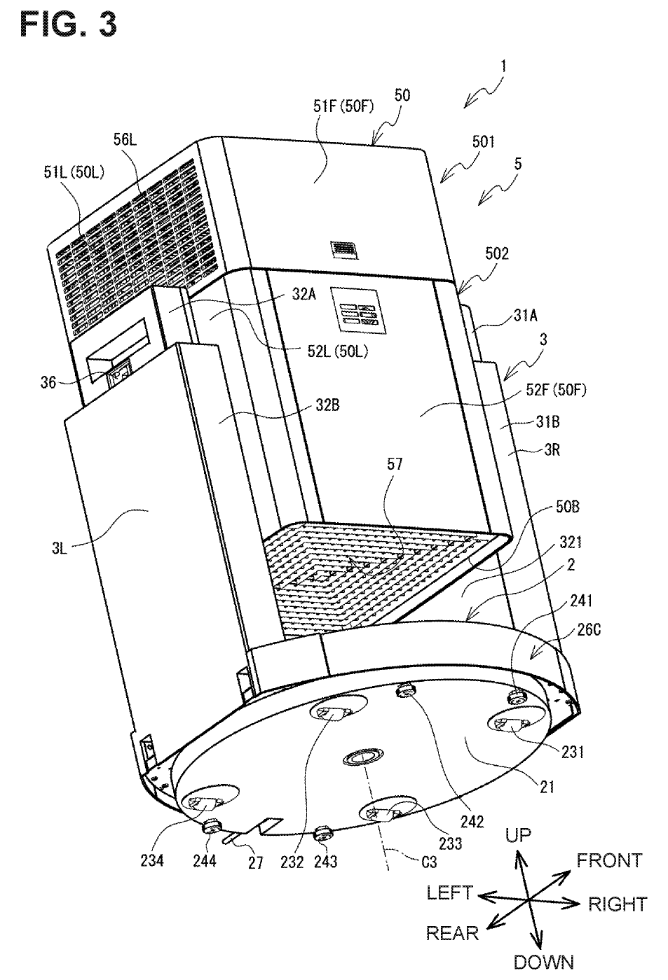

As illustrated in FIG. 3, the base 21 is substantially circular in shape. An imaginary third axis C3 (see FIGS. 2 and 3), extending in the vertical direction through the center of the base 21, is defined. The base 21 is perpendicular to the third axis C3.

Casters 231, 232, 233, and 234 and adjusters 241, 242, 243, and 244 are provided in the lower surface of the base 21 in the vicinity of its peripheral edge. The casters 231 to 234 are provided for moving the air purifier 1 in the horizontal direction. The adjusters 241 to 244 protrude downward from the base 21. The user can adjust the amount by which the adjusters 241 to 244 protrude from the base 21 by rotating the adjusters.

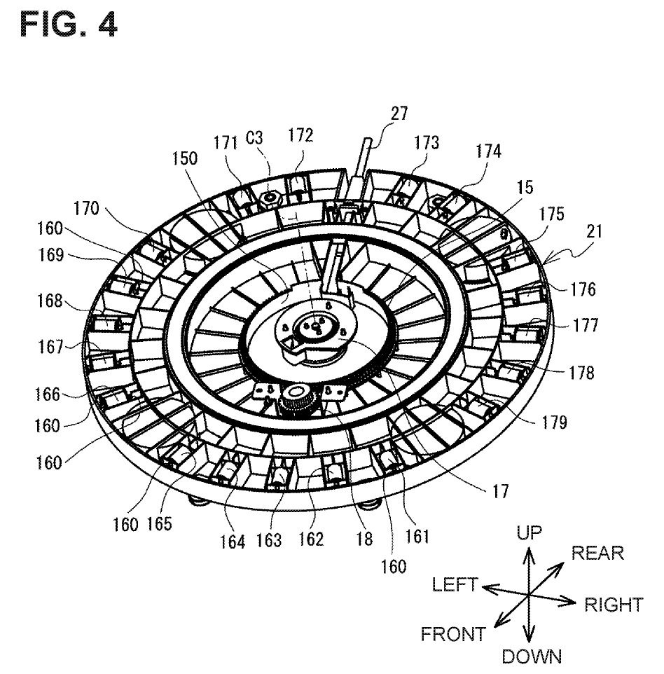

As illustrated in FIG. 4, the base 21 has, on its upper surface, a first gear 15, rollers 161, 162, 163, 164, 165, 166, 167, 168, 169, 170, 171, 172, 173, 174, 175, 176, 177, 178, 179, and a plate member 17. The first gear 15 and the rollers 161 to 179 are provided for rotating the frame 25, which will be described later, relative to the base 21. The plate member 17 is provided for detecting the rotational position by a first sensor 251, which will be described later.

The first gear 15 is provided on the outer surface of a cylindrical wall portion 150 having the third axis C3 as the center. The rollers 161 to 179 are provided in the vicinity of the peripheral edge portion of the base 21. The rollers 161 to 179 are cylindrical in shape. The center lines of the rollers 161 to 179 extend radially from the third axis C3. The rollers 161 to 179 each have two protruding portions 160 that extend from the two opposing bottom surfaces in directions perpendicular to the bottom surfaces. The two protruding portions 160 are rotatably supported by the base 21. The rollers 161 to 179 are rotatable relative to the base 21. The plate member 17 is provided inside the first gear 15. The plate member 17 has a substantially circular shape centered on the third axis C3. The plate member 17 is partially notched.

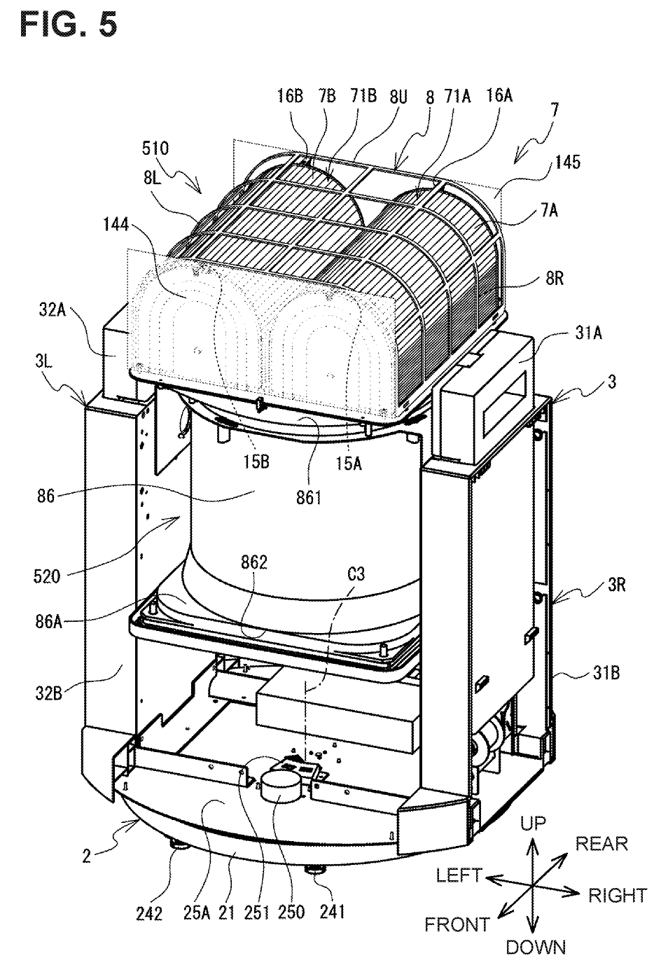

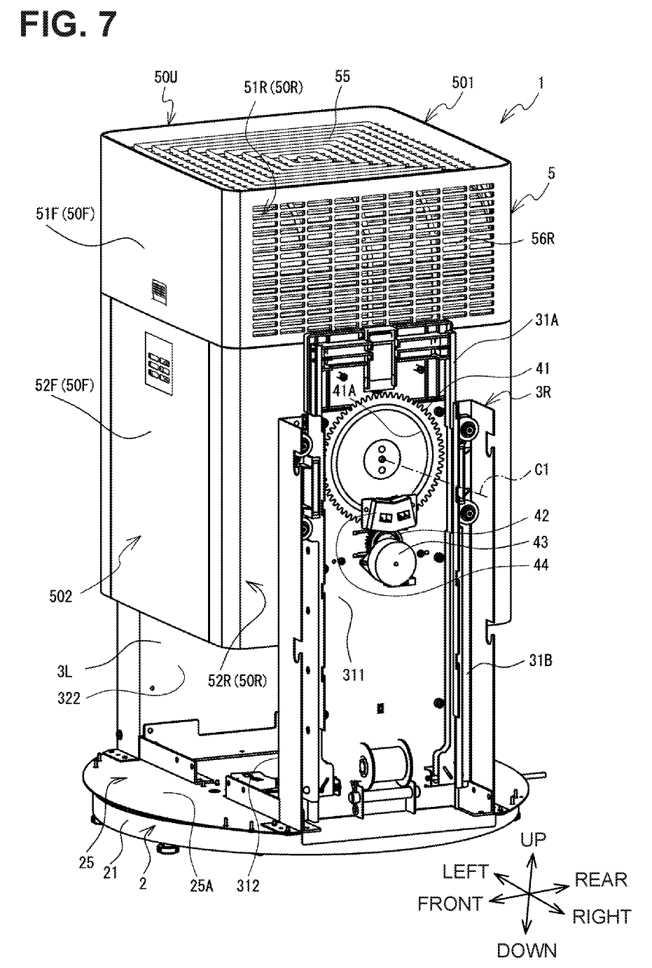

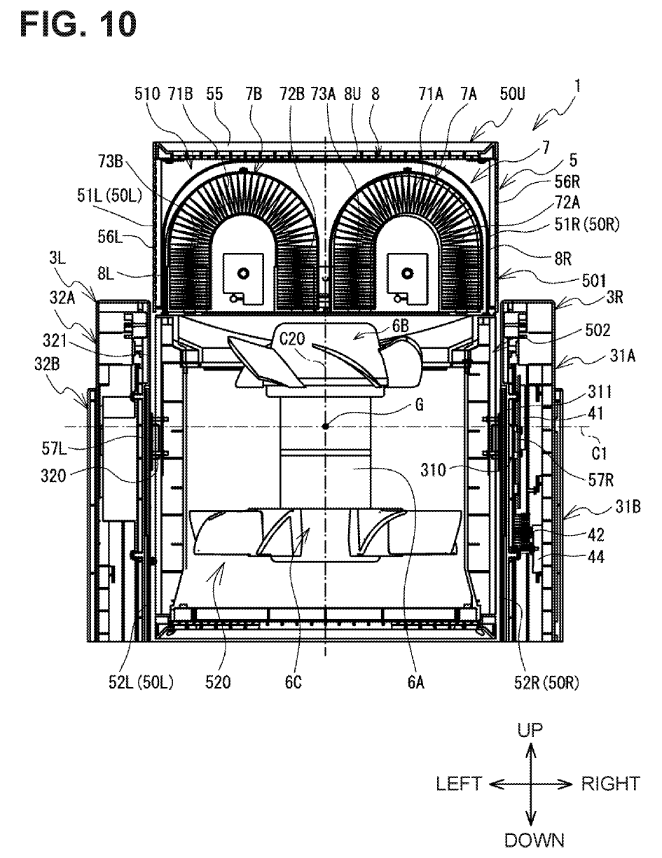

The base 21 is connected to a power cable 27 at its rear end portion. The power cable 27 supplies electric power for driving a first motor 250 (see FIG. 5), a second motor 43 (see FIG. 7), a fan 6 (see FIG. 10), and the like, which will be described later.

As illustrated in FIGS. 1 to 3, the frame 25 is located above the base 21. The frame 25 is supported from below by the base 21. The frame 25 has a bottom wall 25A (see FIG. 5) and a flow directing member 26 (see FIGS. 1 and 2).

As illustrated in FIG. 5, the bottom wall 25A is substantially circular with two sections cut out from its circumference. The rollers 161 to 179 in the base 21 contact the lower surface of the bottom wall 25A. The bottom wall 25A is supported by the rollers 161 to 179 so as to be rotatable about the third axis C3. In the following, unless otherwise described, the directions (front-rear direction, left-right direction, and vertical direction) of each component will be described with reference to a state in which two cut-out portions of the bottom wall 25A are located opposite each other in the left-right direction (state shown in FIG. 1).

The bottom wall 25A is provided, on its upper surface and in front of the third axis C3, with a first motor 250 and a first sensor 251. The first motor 250 has a rotation shaft extending downward. A second gear 18 illustrated in FIG. 4 is connected to the rotation shaft of the first motor 250. The second gear 18 meshes with the first gear 15 of the base 21. When the first motor 250 rotates, the second gear 18 moves in a circumferential direction along the first gear 15. Thus, the frame 25 rotates about the third axis C3 relative to the base 21. The first sensor 251 is located behind the first motor 250. The first sensor 251 can detect the position of the notch formed in the plate member 17 of the base 21 illustrated in FIG. 4.

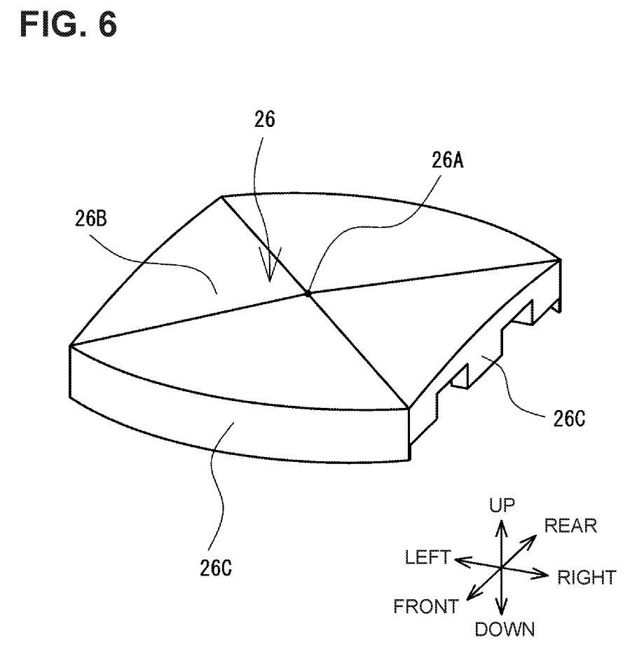

As illustrated in FIG. 2, the flow directing member 26 is located above the bottom wall 25A and covers the bottom wall 25A. As illustrated in FIG. 6, the flow directing member 26 has a top portion 26A, inclined portions 26B, and side surface portions 26C. The top portion 26A and the inclined portions 26B define a substantially quadrangular pyramid shape. The top portion 26A corresponds to the apex of the substantially quadrangular pyramid. The top portion 26A is located at the uppermost position in the vertical direction of the flow directing member 26. The top portion 26A is disposed at a position overlapping the third axis C3. The inclined portions 26B correspond to side surfaces of a substantially quadrangular pyramid. The inclined portions 26B extend downward from the top portion 26A in directions inclined relative to the vertical direction. The side surface portions 26C extend downward from the lower end portions of the inclined portions 26B.

As illustrated in FIG. 2, the apex angle of the flow directing member 26, when viewed from the front, corresponds to the angle formed between two bus lines extending from the top portion 26A along an inclined portion 26B. The apex angle of the flow directing member 26 is, for example, 170 degrees.

### Support 3

The support 3 rotates about the third axis C3 in response to the rotation of the frame 25 of the base body 2. The support 3 rotatably supports the fan unit 5 described later. As illustrated in FIG. 1, the support 3 has a right support 3R and a left support 3L. The right support 3R is connected to the right end of the frame 25 of the base body 2. The left support 3L is connected to the left end of the frame 25 of the base body 2. The right support 3R and the left support 3L are located opposite each other with a space in the left-right direction.

The right support 3R has a second right housing 31A and a third right housing 31B. The second right housing 31A and the third right housing 31B are each shaped like a rectangular parallelepiped that is long in the vertical direction. The third right housing 31B extends upward from the right end of the frame 25 of the base body 2. The second right housing 31A has shorter lengths than the third right housing 31B in both the front-rear and the left-right directions. As illustrated in FIG. 5, the second right housing 31A and the third right housing 31B have substantially the same length in the vertical direction. The upper end portion of the second right housing 31A is located above the upper end portion of the third right housing 31B. The remainder of the second right housing 31A, excluding its upper end portion, is disposed within the third right housing 31B. The left side wall of the third right housing 31B is referred to as a third right support wall 312.

The second right housing 31A is movable in the vertical direction relative to the third right housing 31B. A handle for the user to grip and move the second right housing 31A in the vertical direction is provided at a portion of the second right housing 31A protruding upward beyond the third right housing 31B.

As illustrated in FIG. 7, the second right housing 31A has, inside, a third gear 41, a fourth gear 42, a second motor 43, and a second sensor 44. The third gear 41 is a spur gear. An imaginary first axis C1 extending along the rotation center of the third gear 41 extends horizontally in the left-right direction. The first axis C1 is perpendicular to the third axis C3 (see FIG. 2). The position of the first axis C1 moves in the vertical direction as the second right housing 31A moves vertically relative to the third right housing 31B.

As illustrated in FIG. 10, a right protruding portion 57R, which extends rightward from the fan unit 5 to be described later, is connected to a portion of the left surface of the third gear 41 intersecting the first axis C1. The right protruding portion 57R is inserted through a substantially circular right through hole 310 provided in the second right support wall 311, which is the left side wall of the second right housing 31A. The first axis C1 passes through the center of the right through hole 310. As illustrated in FIG. 7, the third gear 41 has, on its right surface, a substantially circular stepped portion 41A extending around the first axis C1. The stepped portion 41A is partially notched.

The fourth gear 42 is disposed below the third gear 41. The fourth gear 42 has its axis of rotation extending horizontally in the left-right direction. The fourth gear 42 is a two-stage gear in which two gears having different diameters are connected in the left-right direction. Of the two gears, the left gear has a larger diameter than the right gear. The left gear of the fourth gear 42 meshes with the third gear 41. The fourth gear 42 is rotatably supported on the right surface of the second right support wall 311 of the second right housing 31A.

The second motor 43 is located to the right of the fourth gear 42. The second motor 43 is fixed at a position slightly spaced to the right relative to the second right support wall 311. The second motor 43 has a rotation shaft extending leftward. A gear provided on the rotation shaft of the second motor 43 meshes with the right gear of the fourth gear 42. The rotation of the second motor 43 causes the third gear 41 to rotate about the first axis C1 relative to the second right housing 31A.

The second sensor 44 is located to the right of the third gear 41. The second sensor 44 can detect the position of the notch formed in the stepped portion 41A of the third gear 41.

As illustrated in FIG. 5, the left support 3L has a second left housing 32A and a third left housing 32B. The third left housing 32B extends upward from the left end of the frame 25 of the base body 2. The second left housing 32A is movable in the vertical direction relative to the third left housing 32B. An operation panel 36 is provided on the left surface of the second left housing 32A. The left side wall of the third left housing 32B is referred to as a third left support wall 322.

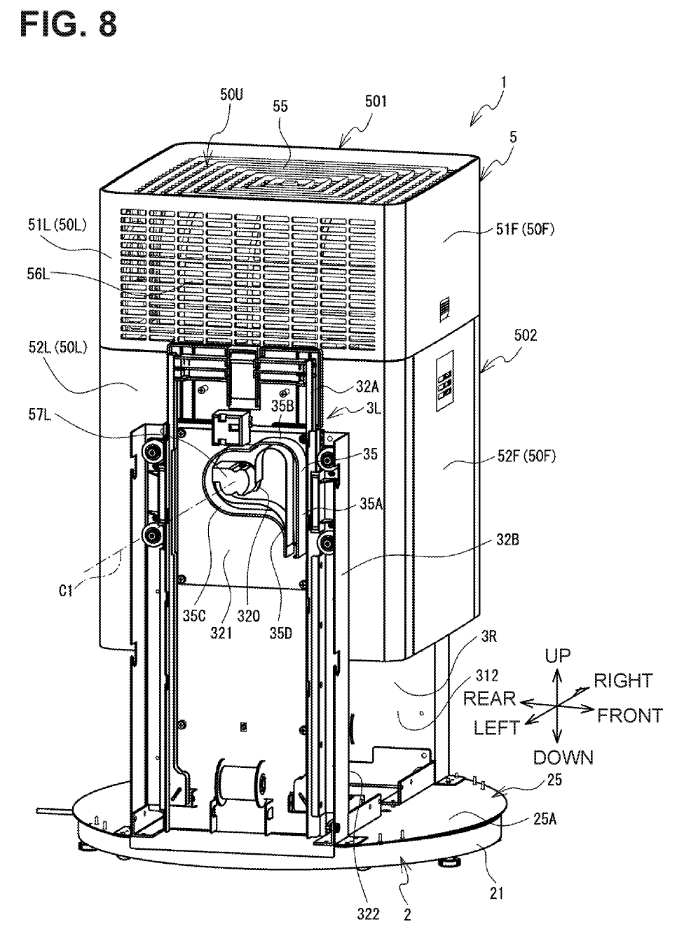

As illustrated in FIGS. 8 and 10, the second left support wall 321, which is the right side wall of the second left housing 32A, has a substantially circular left through hole 320. The first axis C1 passes through the center of the left through hole 320. The left through hole 320 receives a left protruding portion 57L, which extends leftward from the fan unit 5, which will be described later.

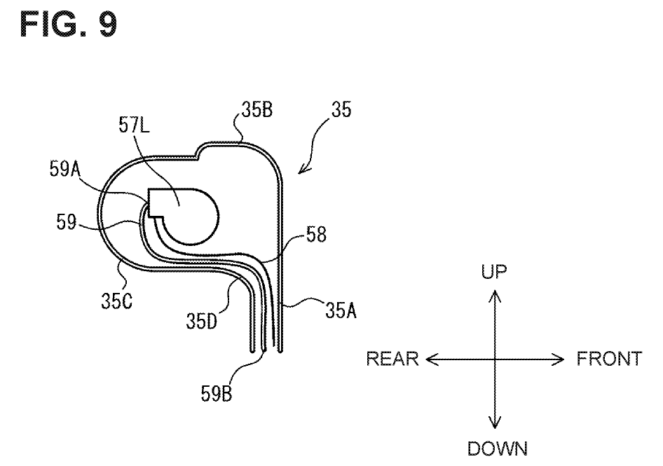

As illustrated in FIGS. 8 and 9, the second left support wall 321 is provided with an elongate, plate-shaped restriction plate 35. The restriction plate 35 has a first portion 35A, a second portion 35B, a third portion 35C, and a fourth portion 35D. The first portion 35A extends linearly upward from a position near the front end of the second left support wall 321 and below the left through hole 320. The second portion 35B extends from the upper end of the first portion 35A, curving rearward. The third portion 35C extends from the rear end of the second portion 35B, curving rearward, downward, and forward. The fourth portion 35D extends from the front end of the third portion 35C, curving downwardly. The rear end of the fourth portion 35D is located near the rear of the first portion 35A. The restriction plate 35 covers the periphery of the left protruding portion 57L.

As illustrated in FIG. 9, the left protruding portion 57L is connected to a cable 58 and a guide portion 59 for supplying electric power to the fan 6. The guide portion 59 has an elongated plate shape and is flexible. The guide portion 59 has one end 59A connected to the left protruding portion 57L. The other end 59B of the guide portion 59 is connected near the lower ends of both the first portion 35A and the fourth portion 35D of the restriction plate 35 of the second left support wall 321 of the second left housing 32A.

The guide portion 59 extends downwardly in a curved manner from the rear end of the left protruding portion 57L, extends to the front along the third portion 35C of the restriction plate 35, curves downwardly, and extends downwardly along the fourth portion 35D. The downward movement of the guide portion 59 is restricted by the third portion 35C and the fourth portion 35D of the restriction plate 35. The cable 58 extends downward from the connection portion with the left protruding portion 57L, then toward the front along the guide portion 59, and then downward again. The cable 58 is disposed along the guide portion 59. The cable 58 is positioned between the first portion 35A and the second portion 35B of the restriction plate 35 and the guide portion 59.

### Fan Unit 5

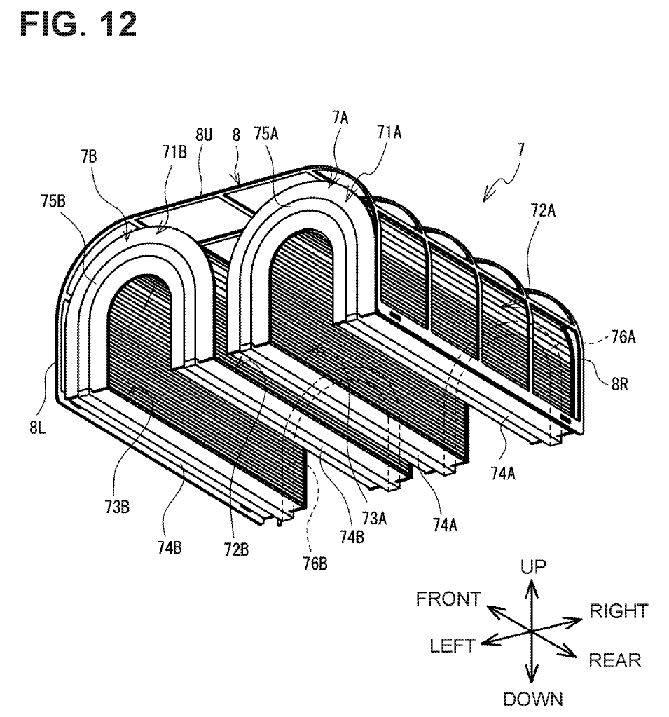

The fan unit 5 draws air inside, and removes the removal targets, and discharges the air, from which the removal targets have been removed, to the outside. The air purifier 1 thus purifies the surrounding air. The fan unit 5 is rotatably supported by the support 3. The fan unit 5 includes a first housing 50 (see FIGS. 1 to 3), a fan 6 (see FIGS. 10, 11, and FIG. 13), a first filter 7 (see FIGS. 5, 10, and FIG. 12), and a second filter 8 (see FIGS. 5 and 12).

First Housing 50

As illustrated in FIGS. 1 to 3, the first housing 50 is shaped like a rectangular parallelepiped. The orientation of the first housing 50 changes as the fan unit 5 rotates relative to the support 3. In the following, unless otherwise described, the directions (front-rear direction, left-right direction, and vertical direction) of the respective configurations will be described with reference to a state in which the longitudinal direction of the first housing 50 is along the vertical direction (the state in FIG. 1).

The first housing 50 has an upper wall surface 50U, a lower wall surface 50B, a front wall surface 50F, a rear wall surface 50S, a right wall surface 50R, and a left wall surface 50L. The upper wall surface 50U and the lower wall surface 50B are perpendicular to the vertical direction. The front wall surface 50F and the rear wall surface 50S are perpendicular to the front-rear direction. The right wall surface 50R and the left wall surface 50L are perpendicular to the left-right direction.

The first housing 50 has an upper housing 501 and a lower housing 502. The upper housing 501 includes the upper wall surface 50U of the first housing 50 and upper portions of the front wall surface 50F, the rear wall surface 50S, the right wall surface 50R, and the left wall surface 50L. The lower housing 502 includes the lower wall surface 50B of the first housing 50 and lower portions of the front wall surface 50F, the rear wall surface 50S, the right wall surface 50R, and the left wall surface 50L. The length of the upper housing 501 in the vertical direction is approximately ½ the length of the lower housing 502 in the vertical direction.

The front, rear, right, and left wall surfaces of the upper housing 501 are referred to as a first front wall surface 51F, a first right wall surface 51R, a first left wall surface 51L, and a first rear wall surface 51S. The upper wall surface of the upper housing 501 is the upper wall surface 50U. The front, rear, right, and left wall surfaces of the lower housing 502 are referred to as a second front wall surface 52F, a second right wall surface 52R, a second left wall surface 52L, and a second rear wall surface 52S. The lower wall surface of the upper housing 501 is the lower wall surface 50B.

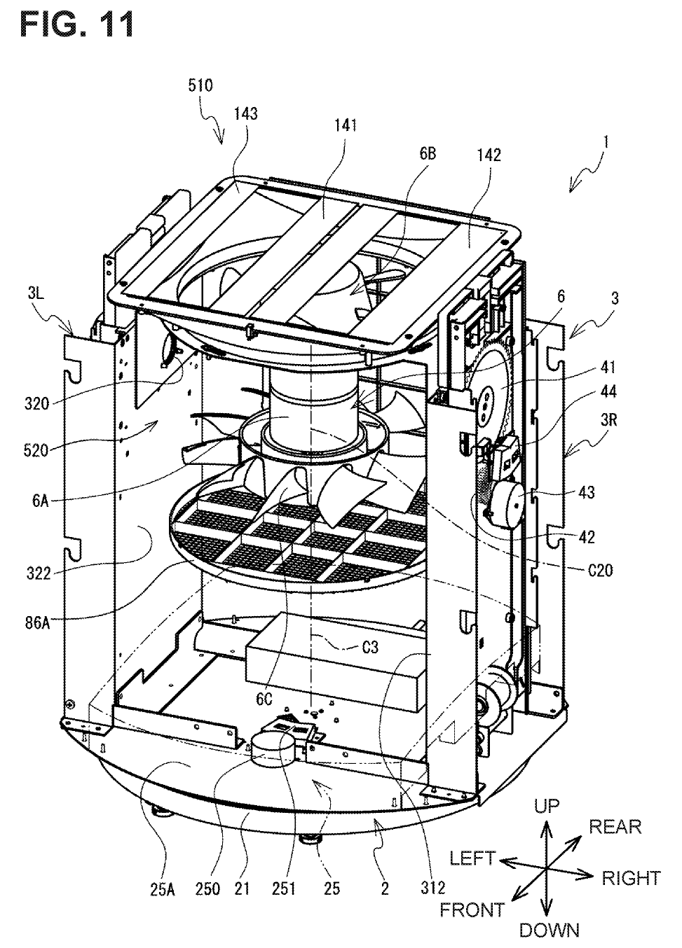

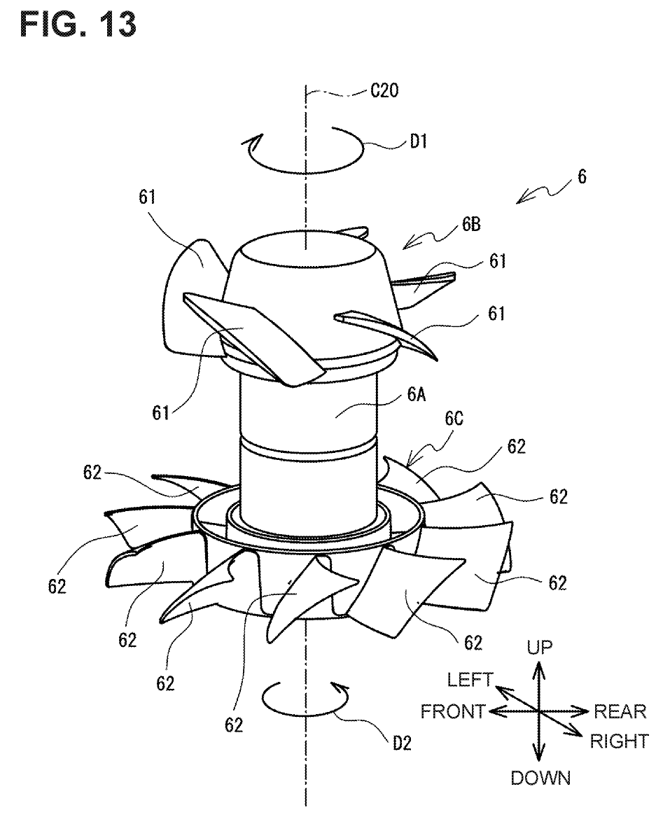

The upper housing 501 defines, in its interior, a first accommodating body 510 (see FIGS. 5, 10, and FIG. 11) for accommodating a first filter 7 and a second filter 8 (see FIGS. 5 and 12) described later. The lower housing 502 defines, in its interior, a second accommodating body 520 (see FIGS. 5, 10, and FIG. 11) for accommodating a fan 6 (see FIGS. 11 and 13) described later.

As illustrated in FIG. 11, the first accommodating body 510 is provided with a first support plate 141, a second support plate 142, and a third support plate 143 for supporting the first filter 7, described later, from below. The first support plate 141, the second support plate 142, and the third support plate 143 have a plate shape. The first support plate 141, the second support plate 142, and the third support plate 143 extend between the upper ends of the second front wall surface 52F and the second rear wall surface 52S (see FIG. 1) of the lower housing 502. The first support plate 141 is connected to the center portions in the left-right direction of the upper ends of the second front wall surface 52F and the second rear wall surface 52S. The second support plate 142 is connected in the vicinity of the right end portions of the upper ends of the second front wall surface 52F and the second rear wall surface 52S. The third support plate 143 is connected in the vicinity of the left end portions of the upper ends of the second front wall surface 52F and the second rear wall surface 52S.

As illustrated in FIG. 5, the first accommodating body 510 is provided with a fourth support plate 144 for supporting the first filter 7 from the front, and a fifth support plate 145 for supporting the first filter 7 from the rear. The fourth support plate 144 and the fifth support plate 145 have a plate shape. The fourth support plate 144 is fixed to the rear of the first front wall surface 51F (see FIG. 1) of the upper housing 501. The fifth support plate 145 is fixed to the front of the first rear wall surface 51S (see FIG. 1) of the upper housing 501.

A first holding portion 15A and a second holding portion 15B are provided at the upper end of the fourth support plate 144. The first holding portion 15A is located to the right of the center of the fourth support plate 144 in the left-right direction. The second holding portion 15B is located to the left of the center of the fourth support plate 144 in the left-right direction. A third holding portion 16A and a fourth holding portion 16B are provided at the upper end of the fifth support plate 145. The third holding portion 16A is located to the right of the center of the fifth support plate 145 in the left-right direction. The fourth holding portion 16B is located to the left of the center of the fifth support plate 145 in the left-right direction.

The first holding portion 15A, the second holding portion 15B, the third holding portion 16A, and the fourth holding portion 16B each have a rod shape. The first holding portion 15A and the second holding portion 15B each have one end rotatably supported by the fourth support plate 144 about an axis extending in the vertical direction. The first holding portion 15A and the second holding portion 15B can be switched, by rotation, between a state in which the first holding portion 15A and the second holding portion 15B protrude rearward relative to the fourth support plate 144 and a state in which the first holding portion 15A and the second holding portion 15B do not protrude rearward relative to the fourth support plate 144. The third holding portion 16A and the fourth holding portion 16B each have one end rotatably supported by the fifth support plate 145 about an axis extending in the vertical direction. The third holding portion 16A and the fourth holding portion 16B can be switched, by rotation, between a state in which the third holding portion 16A and the fourth holding portion 16B protrude forward relative to the fifth support plate 145 and a state in which the third holding portion 16A and the fourth holding portion 16B do not protrude forward relative to the fifth support plate 145.

A cylindrical frame 86 is located in the second accommodating body 520. The frame 86 extends in the vertical direction. The frame 86 has, at its upper end, an upper opening 861 that interconnects with the first accommodating body 510. The frame 86 has, at its lower end, a lower opening 862 located above the lower wall surface 50B (see FIG. 3) of the first housing 50. A lattice-shaped louver 86A (see FIGS. 5 and 11) is interposed between the lower opening 862 of the frame 86 and the lower wall surface 50B.

As illustrated in FIGS. 2 and 10, the right protruding portion 57R protruding to the right is located on the second right wall surface 52R of the lower housing 502. The right protruding portion 57R is inserted from the left into the right through hole 310 provided in the second right support wall 311 (see FIG. 7) of the second right housing 31A of the right support 3R. The right protruding portion 57R is connected to the third gear 41 in the second right housing 31A of the right support 3R. The left protruding portion 57L protruding leftward is provided on the second left wall surface 52L of the lower housing 502. The left protruding portion 57L is inserted from the right into a left through hole 320 provided in the second left support wall 321 of the second left housing 32A of the left support 3L.

The first housing 50 is disposed inward relative to the right support 3R and the left support 3L in the left-right direction. The first housing 50 is supported by the right support 3R and the left support 3L so as to be rotatable about the first axis C1. The first axis C1 is located at a point where a resultant force, equivalent to the action of gravity acting on each part of the fan unit 5, acts, that is, at a position passing through the center of gravity G. The center of gravity G of the fan unit 5 is located approximately at the center of the first housing 50 in the vertical direction, the lateral direction, and the vertical direction.

As illustrated in FIG. 1, a first inlet 55 is provided in the upper wall surface 50U of the first housing 50. As illustrated in FIGS. 1 and 2, a second right inlet 56R is provided in the right wall surface 50R of the first housing 50, and more specifically, in the first right wall surface 51R of the upper housing 501. As illustrated in FIGS. 2 and 3, a second left inlet 56L is provided in the left wall surface 50L of the first housing 50, and more specifically, in the first left wall surface 51L of the upper housing 501. The front wall surface 50F of the first housing 50, more specifically, the first front wall surface 51U of the upper housing 501, and the rear wall surface 50S of the first housing 50, more specifically, the first rear wall surface 51S of the upper housing 501 are all closed, and no inlets are provided. As illustrated in FIG. 3, the lower wall surface 50B of the first housing 50 is provided with an outlet 57.

The first inlet 55 and the outlet 57 include a plurality of through holes formed by gaps between a plurality of blades. The second right inlet 56R and the second left inlet 56L respectively include a plurality of through holes extending through the first right wall surface 51R and the first right wall surface 51R of the upper housing 501. The first inlet 55, the second right inlet 56R, and the second left inlet 56L are inlets for drawing air from outside the first housing 50 into the interior thereof. The outlet 57 is an outlet for discharging air from the interior of the first housing 50 to the outside.

An imaginary second axis C2 is defined. This axis extends in a direction perpendicular to the upper wall surface 50U of the first housing 50 provided with the first inlet 55. The lower wall surface 50B of the first housing 50 provided with the outlet 57 intersects the second axis C2. The second axis C2 is perpendicular to the first axis C1 passing through the rotation center of the first housing 50. As illustrated in FIG. 2, the second axis C2 passing through the center of the upper wall surface 50U is particularly referred to as "second axis C20". In a state where the longitudinal direction of the first housing 50 is along the vertical direction, the second axis C20 and the third axis C3 corresponding to the rotation center of the base 21 of the base body 2 are aligned on a straight line in the vertical direction. The right wall surface 50R of the first housing 50 provided with the second right inlet 56R and the left wall surface 50L of the first housing 50 provided with the second left inlet 56L intersect the first axis C1.

### First Filter 7

As illustrated in FIG. 5, the first filter 7 is accommodated in a first accommodating body 510 surrounded by the upper housing 501 (see FIG. 1). The first filter 7 is a HEPA (High Efficiency Particulate Air) filter. The first filter 7 removes the removal targets from the air drawn in through the first inlet 55, the second right inlet 56R, and the second left inlet 56L, thereby purifying the air. As shown in FIG. 12, the first filter 7 has a right filter 7A and a left filter 7B. The right filter 7A and the left filter 7B have the same shape.

The right filter 7A has a shape in which mountain folds and valley folds are repeatedly formed in a thick plate-shaped filter base material, that is, an accordion fold shape. The folds of the right filter 7A extends in the front-back direction. The right filter 7A has a main purification portion 71A, a first auxiliary purification portion 72A, and a second auxiliary purification portion 73A. The main purification portion 71A is in the shape of a sector which curves convexly upward when viewed from the front. The first auxiliary purification portion 72A extends linearly downward from the right end of the main purification portion 71A. The second auxiliary purification portion 73A extends linearly downward from the left end of the main purification portion 71A.

The left filter 7B has a main purification portion 71B, a first auxiliary purification portion 72B, and a second auxiliary purification portion 73B. The main purification portion 71B, the first auxiliary purification portion 72B, and the second auxiliary purification portion 73B correspond to the main purification portion 71A, the first auxiliary purification portion 72A, and the second auxiliary purification portion 73A of the right filter 7A, respectively.

The right filter 7A and the left filter 7B are located adjacent to each other in the left-right direction. The right filter 7A is located to the right of the left filter 7B. As illustrated in FIG. 10, the main purification portion 71A of the right filter 7A and the main purification portion 71B of the left filter 7B are located within the first accommodating body 510, positioned below the upper wall surface 50U of the first housing 50 where the first inlet 55 is provided, and face the upper wall surface 50U. The first auxiliary purification portion 72A of the right filter 7A is located within the first accommodating body 510, to the left of the right wall surface 50R of the first housing 50 where the second right inlet 56R is provided, more specifically, to the left of the first right wall surface 51R of the upper housing 501, and faces the first right wall surface 51R. The second auxiliary purification portion 73Bof the left filter 7B is located within the first accommodating body 510, to the right of the left wall surface 50L of the first housing 50 where the second left inlet 56L is provided, more specifically, to the right of the first left wall surface 51L of the upper housing 501, and faces the first left wall surface 51L.

The second auxiliary purification portion 73A of the right filter 7A and the first auxiliary purification portion 72B of the left filter 7B face each other in the left-right direction.

As illustrated in FIG. 12, first lower elastic members74A are joined to the lower ends of the first auxiliary purification portion 72A and the second auxiliary purification portion 73A of the right filter 7A. Second lower elastic members 74B are provided at the lower ends of the first auxiliary purification portion 72B and the second auxiliary purification portion 73B of the left filter 7B. A first front elastic member 75A is provided at the front ends of the main purification portion 71A, the first auxiliary purification portion 72A, and the second auxiliary purification portion 73A of the right filter 7A. A first rear elastic member 76A is provided at the rear ends of the main purification portion 71A, the first auxiliary purification portion 72A, and the second auxiliary purification portion 73A of the right filter 7A. A second front elastic member 75B is provided at the front ends of the main purification portion 71B, the first auxiliary purification portion 72B, and the second auxiliary purification portion 73B of the left filter 7B. A second rear elastic member 76B is provided at the rear ends of the main purification portion 71B, the first auxiliary purification portion 72B, and the second auxiliary purification portion 73B of the left filter 7B. The first lower elastic members 74A, the second lower elastic members 74B, the first front elastic member 75A, the second front elastic member 75B, the first rear elastic member 76A, and the second rear elastic member 76B each have a rod shape and extend along the right filter 7A or the left filter 7B. The first lower elastic members 74A, the second lower elastic members 74B, the first front elastic member 75A, the second front elastic member 75B, the first rear elastic member 76A, and the second rear elastic member 76B are elastically deformable sponges.

The first filter 7 accommodated in the first accommodating body 510 is placed on the first support plate 141, the second support plate 142, and the third support plate 143 illustrated in FIG. 11. The first auxiliary purification portion 72A of the right filter 7A is located above the second support plate 142. The second auxiliary purification portion 73A of the right filter 7A and the first auxiliary purification portion 72B of the left filter 7B are located above the first support plate 141. The second auxiliary purification portion 73B of the left filter 7B is located above the third support plate 143. The first lower elastic members 74A and the second lower elastic members74B are interposed between the first filter 7, the first support plate 141, the second support plate 142, and the third support plate 143. In other words, the first lower elastic members 74A are located downstream of the right filter 7A in a specific direction D and are sandwiched between the right filter 7A and the first accommodating body 510. The second lower elastic members 74B are located downstream of the left filter 7B in the specific direction D and is sandwiched between the left filter 7B and the first accommodating body 510. The first lower elastic members 74A and the second lower elastic members 74B fill the gap between the first filter 7 and the first support plate 141, the second support plate 142, and the third support plate 143 by being elastically deformed.

The first filter 7 accommodated in the first accommodating body 510 is sandwiched between the fourth support plate 144 and the fifth support plate 145 illustrated in FIG. 5 in the front-rear direction. The front end of the first filter 7 is located behind the fourth support plate 144. The rear end of the first filter 7 is located in front of the fifth support plate 145. The first front elastic member 75A and the second front elastic member75B (see FIG. 12) are interposed between the first filter 7 and the fourth support plate 144. The first rear elastic member 76A and the second rear elastic member 76B (see FIG. 12) are interposed between the first filter 7 and the fifth support plate 145. The first front elastic member 75A, the second front elastic member 75B, the first rear elastic member 76A, and the second rear elastic member 76B fill the gaps between the first filter 7, the fourth support plate 144, and the fifth support plate 145 by being elastically deformed.

The first holding portion 15A and the third holding portion 16A contact both ends in the front-rear direction of the main purification portion 71A of the right filter 7A accommodated in the first accommodating body 510 from above. The second holding portion 15B and the fourth holding portion 16B contact both ends in the front-rear direction of the main purification portion 71B of the left filter 7B accommodated in the first accommodating body 510 from above. Thus, the first holding portion 15A, the second holding portion 15B, the third holding portion 16A, and the fourth holding portion 16B hold the first filter 7 from above.

### Second Filter 8

The second filter 8 is a pre-filter. The second filter 8 is located upstream of the first filter 7 and removes coarse particles from among the removal targets present in the air drawn in through the first inlet 55, the second right inlet 56R, and the second left inlet 56L. As illustrated in FIG. 12, the second filter 8 has an upper cover portion 8U, a right cover portion 8R, and a left cover portion 8L.

The upper cover portion 8U is positioned above the first filter 7. The right cover portion 8R extends downward in a curved manner from the right end portion of the upper cover portion 8U. The right cover portion 8R is located to the right of the right filter 7A of the first filter 7. The left cover portion 8L extends downward in a curved manner from the left end portion of the upper cover portion 8U. The left cover portion 8L is located to the left of the left filter 7B of the first filter 7.

As illustrated in FIG. 10, the upper cover portion 8U of the second filter 8 is located below the upper wall surface 50U of the first housing 50 provided with the first inlet 55. The right cover portion 8R of the second filter 8 is located on the right wall surface 50R of the first housing 50, where the second right inlet 56R is provided, and more specifically, is located to the left of the first right wall surface 51R of the upper housing 501. The left cover portion 8L of the second filter 8 is located on the left wall surface 50L of the first housing 50, where the second left inlet 56L is provided, and more specifically, is located to the right of the first left wall surface 51L of the upper housing 501. The second filter 8 is interposed between the first filter 7 and the upper housing 501 in a state where the first filter 7 is housed in the first accommodating body 510 of the upper housing 501.

### Fan 6

As illustrated in FIG. 11, the fan 6 is accommodated in a second accommodating body 520 surrounded by a lower housing 502 and is disposed in the frame 86 illustrated in FIG. 5. The fan 6 is a so-called counter-rotating type axial flow fan. As illustrated in FIG. 13, the fan 6 has a propeller shaft 6A, a first propeller 6B, and a second propeller 6C. The propeller shaft 6A has a cylindrical shape. The center of the propeller shaft 6A extends along the second axis C20. The first propeller 6B is provided at the upper end of the propeller shaft 6A. The first propeller 6B has a plurality of first blades 61. The diameter of the first propeller 6B corresponds to a radial length between the second axis C20 and the tips of the plurality of first blades 61. The second propeller 6C is provided at the lower end of the propeller shaft 6A. The second propeller 6C has a plurality of second blades 62. The diameter of the second propeller 6C corresponds to a radial length between the second axis C20 and the tips of the plurality of second blades 62. The diameter of the second propeller 6C is larger than the diameter of the first propeller 6B. The second blades 62 of the second propeller 6C outnumber the first blades 61 of the first propeller 6B.

A motor (not illustrated) is provided for the fan 6, and power is supplied to the motor via a cable 58 connected to the left protruding portion 57L of the first housing 50, thereby driving the fan 6 to rotate. When the fan 6 is driven, the first propeller 6B rotates in the first rotational direction D1 at a first rotational speed V1. The second propeller 6C rotates in the second rotational direction D2 at a second rotational speed V2. The first rotational direction D1 is a clockwise direction when the fan 6 is viewed from above. The second rotational direction D2 is a counterclockwise direction when the fan 6 is viewed from above. The first rotational direction D1 is opposite to the second rotational direction D2. The first rotational speed V1 is, for example, 1000 rpm. The second rotational speed V2 is, for example, 800 rpm. The second rotational speed V2 is less than the first rotational speed V1.

When the fan 6 rotates, air flows into the frame 86. The direction in which air flows is parallel to the imaginary second axis C2 extending in a direction perpendicular to the upper wall surface 50U of the first housing 50 and coincides with a direction from the first inlet 55 of the upper wall surface 50U toward the fan 6. Hereinafter, a direction that is parallel to the second axis C2 and extends from the first inlet 55 toward the fan 6 is referred to as a "specific direction D". As illustrated in FIG. 2, a direction from the first inlet 55 of the upper wall surface 50U toward the fan 6 along the second axis C2 (second axis C20) that passes through the center of the upper wall surface 50U is particularly referred to as "specific direction D0".

In the frame 86, the air flow in the specific direction D is generated, and thus the air is drawn in through the first inlet 55, the second right inlet 56R, and the second left inlet 56L. The drawn-in air is discharged from the outlet 57.

A state in which the angle of the fan unit 5 is adjusted so that the first inlet 55 is entirely located above the fan 6 in the vertical direction is referred to as a "predetermined state". FIG. 15 illustrates examples of such predetermined states in cases where the vertical position of the fan unit 5 or the rotational state of the fan unit 5 changes. In the predetermined states, the first inlet 55 is located at the most upstream position in the specific direction D. In the predetermined states, the upstream region of the first inlet 55 in the specific direction D is in an open state. In the predetermined states, no other component of the air purifier 1 is provided upstream of the first inlet 55 in the specific direction D.

### Outline of Operation (Horizontal Movement of Air Purifier 1)

The user rotates the adjusters 241 to 244 illustrated in FIG. 3 so that the lower ends of the adjusters 241 to 244 are positioned above the casters 231 to 234. In this state, when the user applies a force in the front-rear direction to the air purifier 1, the wheels of the casters 231 to 234 rotate, and the air purifier 1 moves in the front-rear direction. The user then rotates the adjusters 241 to 244 so that the lower ends of the adjusters 241 to 244 are positioned below the casters 231 to 234. The casters 231 to 234 are spaced upward from the placement surface. Thus, the adjusters 241 to 244 support the base 21 so as not to move relative to the placement surface.

### Outline of Operation (Up-and-Down Movement and Angle Adjustment of Fan Unit 5)

The user grips the handles of the second right housing 31A and the second left housing 32A of the support 3 and moves them in the vertical direction. Thus, the fan unit 5 supported by the support 3 moves in the vertical direction.

When the user inputs an operation for rotating the air purifier 1 about the third axis C3 via the operation panel 36, the first motor 250 (see FIG. 5) is driven. The rotation of the first motor 250 causes the base 21 of the base body 2, the support 3, and the fan unit 5 to rotate about the third axis C3. Thus, the user adjusts the angle of the fan unit 5 about the third axis C3.

As the base 21 rotates, the position of the notch formed in the plate member 17 (see FIG. 5) is detected by the first sensor 251. The rotation of the first motor 250 is stopped when the notch of the plate member 17 is detected by the first sensor 251. This prevents the fan unit 5 from continuously rotating through 360 degrees or more about the third axis C3.

When the user inputs an operation for rotating the air purifier 1 about the first axis C1 via the operation panel 36, the second motor 43 (see FIG. 7) is driven. The rotation of the second motor 43 causes the fan unit 5 to rotate about the first axis C1. Thus, the user adjusts the angle of the fan unit 5 about the first axis C1. In addition, when the angle of the fan unit 5 about the first axis C1 is changed, the specific direction D is also changed relative to the vertical direction. Thus, the direction in which the first inlet 55 of the air purifier 1 faces also changes in accordance with the adjustment of the angle about the first axis C1 of the fan unit 5.

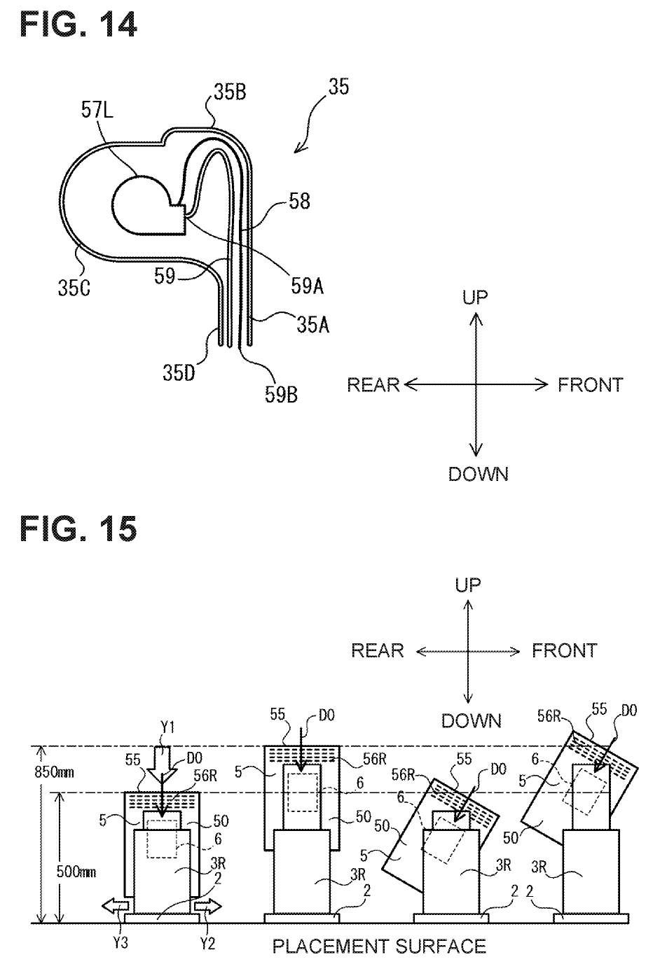

As the fan unit 5 rotates about the first axis C1, the left protruding portion 57L rotates from the state illustrated in FIG. 9 to, for example, the state illustrated in FIG. 14. As illustrated in FIG. 14, the guide portion 59 extends upward from the front end of the left protruding portion 57L, curves below the second portion 35B of the restriction plate 35, and extends downward behind the first portion 35A. The cable 58 extends upward and then downward along the guide portion 59, starting from the connection portion with the left protruding portion 57L. The cable 58 is disposed along the guide portion 59. The cable 58 is positioned between the first portion 35A and the second portion 35B of the restriction plate 35 and the guide portion 59.

As illustrated in FIG. 15, in a state where the longitudinal direction of the first housing 50 of the fan unit 5 is along the vertical direction and the fan unit 5 is located so that the specific directions D and D0 extend downward in the vertical direction, the second axis C20 and the third axis C3 are aligned in the vertical direction, and the first filter 7 is positioned above the fan 6 in the vertical direction. In this state, the height from the placement surface to the lowermost portion of the first inlet 55 is always 500 mm or more regardless of the vertical position of the fan unit 5. Further, the height from the placement surface to the uppermost portion of the first inlet 55 is always 850 mm or less regardless of the vertical position of the fan unit 5.

### Outline of Operation (Air Purification)

When the user inputs an operation for driving the air purifier 1 via the operation panel 36, the supply of electric power to the fan 6 is started. The first propeller 6B and the second propeller 6C of the fan 6 rotate. The fan 6 draws in air through the first inlet 55, the second right inlet 56R, and the second left inlet 56L. An arrow Y1 in FIG. 15 indicates a flow of air drawn into the first inlet 55. The drawn-in air passes through the first filter 7 and the second filter 8, thereby removing the removal objects from the air. The fan 6 flows the purified air toward the outlet 57 through the frame 86. The purified air is discharged from the outlet 57 toward the flow directing member 26, between the third right support wall 312 and the third left support wall 322. The flow directing member 26 changes the direction of the air discharged from the outlet 57 to the horizontal direction, and directs the air to flow in the horizontal direction. The airflow in the left and right directions is suppressed by the third right support wall 312 and the third left support wall 322. Thus, the air discharged from the outlet 57 toward the flow directing member 26 flows from the flow directing member 26 toward the front or rear. An arrow Y2 in FIG. 15 indicates the airflow directed toward the front. An arrow Y3 in FIG. 15 indicates the airflow directed toward the rear.

### Operation and Effect of Present Embodiment

The first inlet 55 of the air purifier 1, in a predetermined state, is located at the most upstream of the air purifier 1 in the specific direction D. Thus, the flow of air drawn toward the first inlet 55 is not obstructed by the other configurations of the air purifier 1. Thus, the air purifier 1 can stably maintain the efficiency of air purification by the first filter 7 and the second filter 8 of the fan unit 5, regardless of the direction in which the first inlet 55 faces.

The fan 6 has the first propeller 6B and the second propeller 6C rotating in opposite directions. In this case, the force with which air is drawn in through the first inlet 55, the second right inlet 56R, and the second left inlet 56L can be increased, compared to a case where the fan 6 has only one propeller. The second rotational speed V2 of the second propeller 6C is less than the first rotational speed V1 of the first propeller 6B. In this case, the force with which air is drawn in through the first inlet 55 can be increased, compared to a case where the rotational speeds of the first propeller 6B and the second propeller 6C are the same.

In a state where the fan unit 5 is located so that the specific directions D, D0 extend downward in the vertical direction, the height from the placement surface on which the air purifier 1 is placed to the first inlet 55 is 500 mm or more and 850 mm or less. In this case, droplets released from the mouth of a person can be efficiently drawn in through the first inlet 55.

The air purifier 1 includes the flow directing member 26 below the fan unit 5 in the vertical direction. The top portion 26A of the flow directing member 26 is located at the uppermost position in the vertical direction. The inclined portions 26B of the flow directing member 26 extend downward from the top portion 26A in directions inclined relative to the vertical direction. The flow directing member 26 can smoothly change the direction of the air discharged from the outlet 57 from downward to horizontal, directing the air to flow in the horizontal direction.

The first filter 7 has the main purification portions 71A and 71B facing the upper wall surface 50U, the first auxiliary purification portion 72B facing the first right wall surface 51R, and the second auxiliary purification portion 73B facing the first left wall surface 51L. The upper wall surface 50U is provided with the first inlet 55. The first right wall surface 51R is provided with the second right inlet 56R. The first left wall surface 51L is provided with the second left inlet 56L. Thus, the first filter 7 can efficiently purify the air by securing a large surface area.

The air purifier 1 includes the first accommodating body 510 for housing the first filter 7, and the first lower elastic members 74A and the second lower elastic members 74B, which are located downstream of the first filter 7 in the specific direction D and are sandwiched between the first filter 7 and the first accommodating body 510. This can prevent a gap from being formed between the first accommodating body 510 and the first filter 7. In this case, since air leakage from the gap between the first accommodating body 510 and the first filter 7 can be suppressed, the efficiency of air purification by the first filter 7 can be maintained.

The first holding portion 15A, the second holding portion 15B, the third holding portion 16A, and the fourth holding portion 16B press the first filter 7 against the first support plate 141, the second support plate 142, and the third support plate 143 in the specific direction D, thereby enabling the first support plate 141, the second support plate 142, and the third support plate 143 to be in close contact with the first filter 7. In this case, since air can be prevented from leaking from the gap between the first support plate 141, the second support plate 142, and the third support plate 143, and the first filter 7 and the support plate, the efficiency of air purification by the first filter 7 can be maintained.

The first filter 7 is a HEPA (High Efficiency Particulate Air) filter. A HEPA filter is a high-performance particulate air filter used to remove dirt, dust, and other particles from the air. As the HEPA filter, an air filter having a collection efficiency of ISO Class 35 as defined in ISO 29463 - 1:2011 is used. The second filter 8 is a pre-filter. The second filter 8 can suppress clogging of the first filter 7, and thus, a high purification effect can be maintained for a long time.

The first axis C1 corresponding to the rotation center of the fan unit 5 is disposed at a position passing through the gravity center G of the fan unit 5. In this case, the user can easily rotate the fan unit 5 about the right wall surface 50R.

The cable 58 in the second left housing 32A is disposed along the guide portion 59 inside the restriction plate 35. The guide portion 59 can prevent the cable 58 from moving and becoming entangled in the space in accordance with the rotation of the fan unit 5.

The fan unit 5 has the right wall surface 50R provided with the second right inlet 56R serving as an air inlet. The right wall surface 50R is disposed at a position intersecting the first axis C1. The fan unit 5 has the left wall surface 50L provided with the second left inlet 56L serving as an air inlet. The left wall surface 50L is disposed at a position intersecting the first axis C1. Thus, compared to a case where the fan unit has only the first inlet, a larger amount of air can be drawn in and purified at a time. The support 3 also has a pair of support walls, i.e., a third right support wall 312 and a third left support wall 322. The third right support wall 312 and the third left support wall 322 are disposed at positions intersecting the first axis C1 and rotatably support the fan unit 5. The air to be drawn into the fan unit 5 flows toward the second right inlet 56R and the second left inlet 56L in both the left and right directions. In contrast, the air purified by the fan unit 5 is discharged through the outlet 57 into the space between the third right support wall 312 and the third left support wall 322, and then flows in both the front and rear directions. That is, the direction of the movement of the air drawn in through the second right inlet 56R and the second left inlet 56L (left-right direction) intersects with the movement direction of the air discharged from the outlet 57 (front-rear direction). No air inlets are provided in the first front wall surface 51F and the first rear wall surface 51S of the upper housing 501. Thus, the movement of air in the front or rear direction toward the upper housing 501 is unlikely to occur.

In this case, the flow of air discharged from the outlet 57 helps prevent obstruction of air intake from the second right inlet 56R and the second left inlet 56L. The air purifier 1 can draw in air efficiently and purify the air, and thus, the efficiency in air purification can be stably maintained.

The air purifier 1 can rotate the support 3 and the fan unit 5 around the third axis C3. Thus, the air purifier 1 can draw in and purify air over a wide area in the circumferential direction with the vertical direction as the center.

### Modifications

The present disclosure is not limited to the above embodiment, and various modifications can be made. The air purifier 1 may use an alternative purification member instead of the first filter 7 and the second filter 8 to purify the air. For example, the air purifier 1 may include a UV sterilization device that purifies the air by ultraviolet irradiation. For example, the air purifier 1 may use a photo catalyst to purify the air.

The shapes and sizes of the first propeller 6B and the second propeller 6C of the fan 6 are not limited to those described in the above embodiment. The second blades 62 of the second propeller 6C may be fewer in number than the first blades 61 of the first propeller 6B. The diameter of the second propeller 6C may be smaller than the diameter of the first propeller 6B. The first propeller 6B and the second propeller 6C may have the same shape.

The relationship between the rotational speeds of the first propeller 6B and the second propeller 6C is not limited to that described in the above embodiment. The second rotational speed V2 of the second propeller 6C may be greater than the first rotational speed V1 of the first propeller 6B. The first rotational speed V1 and the second rotational speed V2 may be the same.

The fan 6 may be an axial fan having only one propeller. The fan 6 is not limited to an axial fan, and may be a centrifugal fan or a blower fan.

In the predetermined state, the height from the placement surface on which the air purifier 1 is placed to the first inlet 55 is not limited to that described in the above embodiment. Thus, the height from the placement surface to the first inlet 55 may be smaller than 500 mm or greater than 850 mm.

The shape of the flow directing member 26 is not limited to that described in the above embodiment. For example, the flow directing member 26 may be conical or truncated pyramidal. Further, for example, the flow directing member 26 may have a top portion 26A linearly extending in the left-right direction and an inclined portion 26B extending downward from the top portion 26A, sloping either forward or backward. The inclined portion 26B of the flow directing member 26 may extend downward while being curved. The air purifier 1 may not have the flow directing member 26, but instead may be provided with a horizontally extending plate.

The first filter 7 may not have the right filter 7A and the left filter 7B, but instead may have only one filter. The shape of the first filter 7 is not limited to that described in the above embodiment; other shapes may be used. For example, the first filter 7 may be a flat filter directly attached to the inner surfaces of the upper wall surface 50U where the first inlet 55 is provided, the first right wall surface 51R where the second right inlet 56R is provided, and the first left wall surface 51L where the second left inlet 56L is provided.

The first filter 7 may be directly bonded to the first support plate 141, the second support plate 142, the third support plate 143, the fourth support plate 144, and the fifth support plate 145. In this case, the first filter 7 may not be provided with an elastic member or a holding portion.

The air purifier 1 may have a first filter 7 and a second filter 8 downstream of the fan 6 in the specific direction D. In this case, the second filter 8 may be interposed between the fan 6 and the first filter 7. The air purifier 1 may have only the first filter 7 and not have the second filter 8.

The first axis C1 corresponding to the rotation center of the fan unit 5 may not be disposed at a position passing through the gravity center G of the fan unit 5. For example, the first axis C1 may pass through the center of the first housing 50 in the vertical direction and the center thereof in the front-rear direction. Instead of the cable 58, a slip ring may be provided. The power for driving the fan 6 may be supplied through the slip ring. In this case, the guide portion 59 may be omitted.

The second inlet may be provided in each of the first front wall surface 51F and the first rear wall surface 51S of the upper housing 501. The second inlet may be provided only in each of the first front wall surface 51F and the first rear wall surface 51S of the upper housing 501, and the second right inlet 56R and the second left inlet 56L may be omitted. The first housing 50 may have only the first inlet 55 and may not have the second inlet.

The air purifier 1 may alternately switch the rotational direction of the first motor 250 to reciprocally rotate the fan unit 5 about the third axis C3. In this case, the air purifier 1 may reverse the rotational direction of the first motor 250 each time the first sensor 251 detects the notch of the plate member 17.

The air purifier 1 may alternately switch the rotational direction of the second motor 43 to reciprocally rotate the fan unit 5 about the first axis C1. In this case, the air purifier 1 may reverse the rotational direction of the second motor 43 each time the second sensor 44 detects the notch of the stepped portion 41A.

### Others

The first motor 250 is an example of a "rotary mechanism" of the present disclosure. The second left housing 32A is an example of a "second housing" of the present disclosure. The upper wall surface 50U is an example of a "first wall surface" of the present disclosure. The lower wall surface 50B is an example of a "second wall surface" of the present disclosure. The right wall surface 50R and the left wall surface 50L are each an example of a "third wall surface" of the present disclosure. The first auxiliary purification portions 72A and 72B and the second auxiliary purification portions 73A and 73B are each an example of an "auxiliary purification portion" of the present disclosure.

While the disclosure has been described in detail with reference to the specific embodiment thereof, this is merely an example, and various changes, arrangements and modifications may be applied therein without departing from the spirit and scope of the disclosure.

What is claimed is:

1. An air purifier, comprising:
a fan unit including
a first housing having
a first wall surface provided with a first inlet for drawing in air, and
a second wall surface provided with an outlet for discharging air,
a fan disposed inside the first housing and configured to draw in air through the first inlet, and
a purification member configured to purify the air; and
a support configured to rotatably support the fan unit about a first axis that is an imaginary line extending in a horizontal direction,
wherein the first wall surface is located at a position intersecting a second axis that is an imaginary line orthogonal to the first axis, and
wherein, when a direction that is parallel to the second axis and extends from the first wall surface toward the fan is defined as a specific direction and the first inlet is entirely located above the fan in a vertical direction, the first inlet is located at the most upstream position of the air purifier in the specific direction.

2. The air purifier according to claim 1, wherein the fan includes
a first propeller configured to rotate about the second axis in a first rotational direction, and
a second propeller located downstream of the first propeller in the specific direction and configured to rotate about the second axis in a second rotational direction opposite to the first rotational direction.

3. The air purifier according to claim 2, wherein a rotational speed of the second propeller is less than a rotational speed of the first propeller.

4. The air purifier according to claim 1, wherein, when the fan unit is located such that the specific direction extends downward in the vertical direction, a height from a placement surface where the air purifier is placed to the first inlet is 500 mm or more and 850 mm or less.

5. The air purifier according to claim 1, further comprising a flow directing member disposed below the fan unit in the vertical direction,
wherein the flow directing member includes
a top portion located at the uppermost position in the vertical direction, and
an inclined portion extending downward from the top portion and being inclined relative to the vertical direction.

6. The air purifier according to claim 1, wherein the first housing includes a third wall surface located at a position intersecting the first axis,
the purification member includes a first filter, and
the first filter includes
a main purification portion facing the first wall surface, and
an auxiliary purification portion extending from an end portion of the main purification portion in a direction in which the first axis extends, the auxiliary purification portion facing the third wall surface.

7. The air purifier according to claim 6, further comprising:
an accommodating body configured to accommodate the first body; and
an elastic member disposed downstream of the first filter in the specific direction and sandwiched between the first filter and the accommodating body.

8. The air purifier according to claim 7, further comprising a holding portion configured to contact the main purification portion on an upstream side in the specific direction and hold the first filter accommodated in the accommodating body.

9. The air purifier according to claim 6, wherein the purification member includes a second filter disposed between the first housing and the first filter.

10. The air purifier according to claim 6, wherein the first filter is a HEPA (high efficiency particulate air) filter.

11. The air purifier according to claim 1, wherein the first axis passes through the gravity center of the fan unit.

12. The air purifier according to claim 1,
wherein the fan unit has a protruding portion that protrudes toward the support and is connected to a cable for supplying power to the fan,
wherein the support has
a hole through which the protruding portion passes, and
a second housing forming a space in which the protruding portion, the cable, and a guide portion that guides the cable are accommodated, and
wherein the guide portion has an elongated plate shape, has one end connected to the protruding portion and the other end connected to the second housing.

13. The air purifier according to claim 1,
wherein the fan unit further includes a third wall surface provided with a second inlet for drawing in air, and
wherein the third wall surface is located at a position intersecting the first axis.

14. The air purifier according to claim 13, wherein the support is disposed at a position intersecting the first axis and has a pair of support walls configured to rotatably support the fan unit.

15. The air purifier according to claim 1, further comprising a rotary mechanism configured to rotate the support about a third axis that is an imaginary line extending in the vertical direction.
